(19) United States
(12) Patent Application Publication
(10) Pub. No.: US 2023/0327137 A1
(43) Pub. Date: Oct. 12, 2023

(54) MANUFACTURING METHOD OF ELECTRODE AND CATALYTIC LAYER THEREOF

(71) Applicant: TAIWAN CARBON NANO TECHNOLOGY CORPORATION, Miaoli (TW)

(72) Inventors: Kuang-Che Lee, Miaoli (TW); Chia-Hung Li, Miaoli (TW); Chien-Yao Huang, Miaoli (TW); Chiun-Shian Tsai, Miaoli (TW); Ting-Chuan Lee, Miaoli (TW); Chiun- Rung Tsai, Miaoli (TW)

(21) Appl. No.: 17/973,730

(22) Filed: Oct. 26, 2022

(30) Foreign Application Priority Data
Oct. 27, 2021 (TW) 110139951

(51) Int. Cl. H01M 4/88; H01M 4/86

(52) U.S. Cl. CPC H01M 4/8896; H01M 4/8807; H01M 4/8673; H01M 4/8668

(57) ABSTRACT

The present invention provides a manufacturing method of an electrode. The method includes steps of: mixing a first catalyst with a first average particle size, a second catalyst with a second average particle size, a first conductive agent, a first adhesive, and a solvent to form a first mixture, wherein a weight ratio of the first catalyst to the second catalyst is 5:1 to 1:5; stirring the first mixture to obtain a second mixture; rolling the second mixture into a catalytic layer; and pressing the catalytic layer with a conductive current collector and a gas diffusion film to obtain the electrode.

### CROSS REFERENCE TO RELATED APPLICATIONS

The application claims the benefits of Taiwan Patent Application No. 110139951, filed on Oct. 27, 2021, at the Taiwan Intellectual Property Office, the disclosures of which are incorporated herein in their entirety by reference.

### FIELD OF THE INVENTION

The present invention relates to a method for manufacturing an electrode and a catalytic layer of the electrode. In particular, the present invention relates to a method for manufacturing an oxygen generating electrode and a catalytic layer of the oxygen generating electrode.

### BACKGROUND OF THE INVENTION

The common oxygen generating apparatus is a continuous oxygen supply equipment. The oxygen generating apparatus uses an electric motor (or an air compressor) to input the air in the atmospheric environment through the molecular sieve to separate the oxygen and nitrogen in the air, and thus a high concentration of oxygen is obtained. Because the oxygen generating apparatus carries out the redox reaction with the electrode based on the principle of a metal-air electrochemical cell, the consumption of oxygen from the outside air on the cathode leads to a decrease in the oxygen production efficiency, so the material of the electrode and its manufacturing method are the key factors affecting the oxygen production efficiency.

In order to carry out a more efficient redox reaction, which catalyst is selected as the material of the catalytic layer of the electrode has become the research focus of a skilled person because the activity of the catalyst has a great influence on the performance of the air electrode. Generally, the air electrode is composed of a catalyst layer containing a catalyst, a conductive current collector, and a gas diffusion membrane. The inventors of the present invention focus on how to select and utilize the catalytic layer material to improve the oxygen production efficiency of the oxygen generating apparatus.

### SUMMARY OF THE INVENTION

The purpose of the present invention is to provide a method for manufacturing an electrode to improve the structure of the electrode catalytic layer, increase the reaction area, and improve the oxygen production efficiency.

In accordance with one aspect of the present invention, a method for manufacturing an electrode is disclosed. The method includes steps of: mixing a first catalyst having a first average particle size, a second catalyst having a second average particle size, a first conductive agent, a first adhesive and a solvent to form a first mixture, wherein a weight ratio of the first catalyst to the second catalyst is 5:1 to 1:5; stirring the first mixture to obtain a second mixture; rolling the second mixture into a catalytic layer; and laminating the catalytic layer, a conductive current collector and a gas diffusion membrane to obtain the electrode.

In accordance with another aspect of the present invention, a method for manufacturing an electrode is disclosed. The method includes steps of: mixing a catalyst, a first conductive agent, a first adhesive and a solvent to form a first mixture, wherein the catalyst includes a relatively large particle size catalyst and a relatively small particle size catalyst; stirring the first mixture to obtain a second mixture; rolling the second mixture into a catalytic layer; and laminating the catalytic layer, a conductive current collector and a gas diffusion membrane to obtain the electrode.

In accordance with another aspect of the present invention, a catalytic layer of an electrode is disclosed. The catalytic layer includes: a relatively large particle size catalyst; a relatively small particle size catalyst; a conductive agent; and an adhesive, wherein: the relatively large particle size catalyst has a first average particle size; the relatively small particle size catalyst has a second average particle size; and the first average particle size is larger than the second average particle size.

### BRIEF DESCRIPTION OF THE DRAWINGS

The above objects and advantages of the present invention will become more immediately apparent to those of ordinary skill in the art upon review of the following detailed description and accompanying drawings.

FIG. 1 is an enlarged schematic view showing the structure of a catalytic layer of an electrode according to an embodiment of the present invention.

FIG. 2 is a flow chart showing the manufacture of the electrode including the catalytic layer in the embodiment of the present invention.

FIG. 3A is a schematic diagram showing an electrode structure according to an embodiment of the present invention.

FIG. 3B is a schematic diagram showing an electrode structure according to another embodiment of the present invention.

FIG. 4 is a schematic diagram showing the structure of an oxygen generating apparatus with the electrodes of the embodiments 1-5 and the comparative example, to perform the test.

FIG. 5 is a line graph showing changes over the current density per unit area and time of the embodiments 1-5 and the comparative example of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; they are not intended to be exhaustive or to be limited to the precise form disclosed. In the preferred embodiments, the same reference numeral represents the same element in each embodiment.

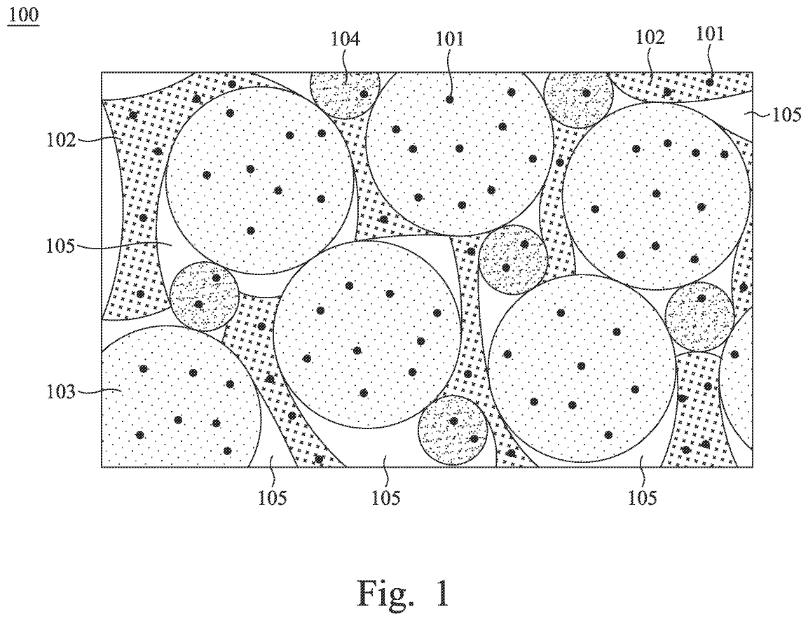

FIG. 1 is an enlarged schematic view showing the structure of a catalytic layer of a cathode according to an embodiment of the present invention. In FIG. 1, the catalytic layer 100 mainly includes a conductive agent 101, an adhesive 102, a large particle size catalyst 103 and a small particle size catalyst 104. The conductive agent 101 is uniformly distributed in the adhesive 102 and on the surfaces of the large particle size catalyst 103 and the small particle size catalyst 104. The adhesive 102 also fixes the large particle size catalyst 103 and the small particle size catalyst 104 together, but even so, there are still fluid channels 105 in the catalyst layer 100, between the large particle size catalysts 103, between the small particle size catalysts 104, and between the large particle size catalysts 103 and the small particle size catalysts 104. The fluid channels 105 also have large and small sizes. The catalytic layer 100 according to the embodiment of the present invention has such structure having catalysts with the mixture of the large and small particle sizes. The large fluid channels 105 are formed by large particle size catalysts, and small fluid channels 105 are formed by small particle size catalysts, so that the fluid channels 105 are closely distributed in the catalytic layer, which can increase the surface area of the catalysts and improve the reaction efficiency to improve the oxygen production efficiency.

In the catalyst layer 100 according to the embodiment of the present invention, the catalyst as the main component includes a large particle size catalyst 103 and a small particle size catalyst 104, wherein “particle size” means “average particle size”. The “average particle size” refers to the D50 value (i.e. the median value of particle size distribution) or the arithmetic mean calculated by, for example, a laser particle size analyzer known in the art. The “average particle size” can be determined by one skilled in the art according to requirements. For example, in order to keep the quality of the product stable, the catalyst particles of the appropriate particle size will be screened with a screen having a specific mesh according to the requirements. In addition, because the shape of the catalyst particles is inconsistent, the particle size is calculated based on the relatively long diameter of the particles. The selected average particle size range of the large particle size catalyst 103 of the present invention is 150-270 μm, and the selected average particle size range of the small particle size catalyst 104 is 5-50 μm. The average particle size of the large particle size catalyst 103 is 3-54 times larger than that of the small particle size catalyst 104.

In the catalyst layer 100 according to the embodiment of the present invention, either of the large particle size catalyst 103 and the small particle size catalyst 104 has a material selected from the group consisting of ruthenium dioxide, iridium dioxide, manganese dioxide, cobalt oxide, tricobalt tetraoxide, nickel hydroxide, nickel oxide, iron oxide, tungsten trioxide, vanadium pentoxide and palladium oxide.

The adhesive 102 has a material selected from a group consisting of polytetrafluoroethylene (PTFE), perfluoroethylene propylene copolymer (FEP) and polyvinylidene fluoride (PVDF). The conductive agent 101 has a material selected from a group consisting of carbon black, acetylene black and carbon nanofibers.

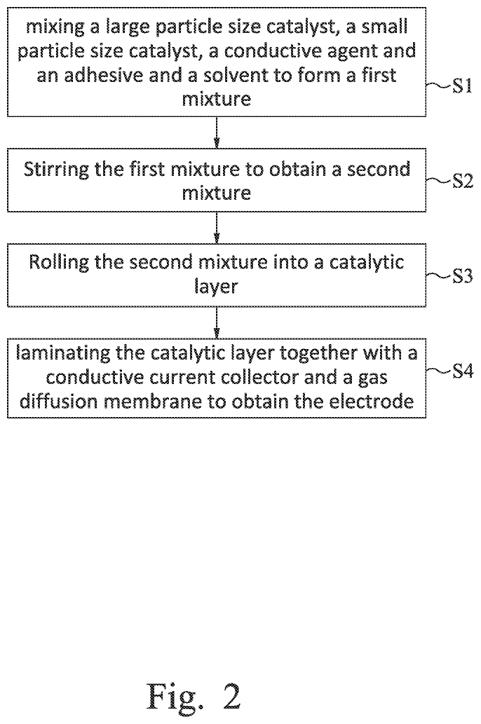

FIG. 2 is a flow chart showing the manufacture of the electrode including the catalyst layer 100 according to the embodiment of the present invention. The steps of the manufacturing method include: step (S1): mixing a large particle size catalyst, a small particle size catalyst, a conductive agent, an adhesive and a solvent to form a first mixture; step (S2): stirring the first mixture to obtain a second mixture; step (S3): rolling the second mixture into a catalytic layer to obtain the above catalytic layer 100. The solvent is water, alcohols, or a combination thereof Then, in order to further manufacture the catalytic layer 100 into an electrode, the solvent is evaporated and exhausted during the electrode manufacturing process, thereby making it easier to generate fluid channels 105 such as pores in the catalytic layer 100. The manufacturing method further includes step (S4): laminating the catalytic layer 100, a conductive current collector and a gas diffusion membrane to obtain the electrode.

The amount of the conductive agent added in the above step (S1) does not exceed half of the total weight of the first mixture, preferably within the range of 20-50%, more preferably within the range of 28-46%. The conductive agent can enhance the conductivity of the electrode. If the conductive agent is added too much, the content of the catalyst will be reduced, and the reaction ability will be deteriorated. For the catalyst added in the above step (S1), the weight ratio of the large particle size catalyst to the small particle size catalyst is 10:1-1:10, preferably 5:1-1:5.

The difference between the mixing step (S1) and the stirring step (S2) is that the step (S1) is a rough mixing and does not require high uniformity, while the step (S2) is performed to achieve high uniformity of the mixture. Therefore, in the mixing step (S1), the rotating speed can be set at 50-800 rpm, preferably 100-700 rpm, more preferably 150-600 rpm. A mixer (blade shear force mixer) commonly used by those in the art can be used for manufacturing the first mixture. A planetary mixer (also known as a gravity centrifugal mixer) can be used for the stirring step (S2), and the rotation speed is set in the range of 200-2000 rpm, preferably 400-1900 rpm, more preferably 500-1400 rpm, to manufacture the second mixture. In addition, the step (S2) is not limited to using a planetary mixer, and can also be performed by a blade shearing mixer, as long as the purpose of uniform distribution of materials can be achieved.

A rolling machine commonly used by those in the art can be used for the rolling step (S3), wherein the rotation speed is set in the range of 1-30 rpm, preferably 2-28 rpm, more preferably 4-26 rpm, and the temperature of the roller is set below 15020 C., preferably 15-100° C., more preferably 20-80° C.

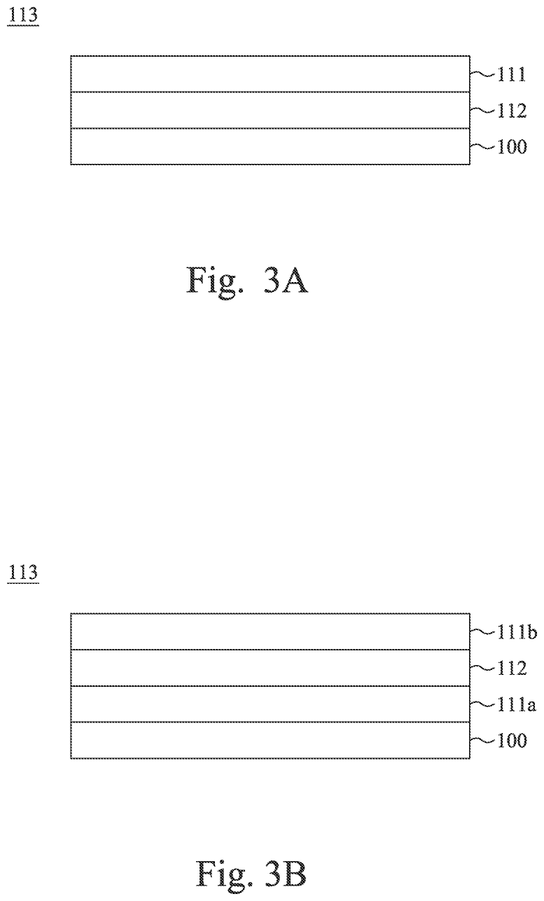

FIG. 3A is a schematic diagram showing an electrode structure according to an embodiment of the present invention. FIG. 3B is a schematic diagram showing an electrode structure according to another embodiment of the present invention. As shown in FIG. 3A, the cathode 113 is formed by laminating the conductive current collector 112 on the catalytic layer 100, and laminating the gas diffusion membrane 111 on the conductive current collector 112. In addition, as shown in FIG. 3B, the first gas diffusion membrane 111a is laminated on the catalytic layer 100, followed by the conductive current collector 112 is laminated on the first gas diffusion membrane 111a, and finally the second gas diffusion membrane 111b is laminated on the conductive current collector 112. The electrode of the four-layer structure can provide a more stable reaction than that of the three-layer structure because the gas diffusion membrane 111 has a better bond with the conductive current collector 112.

The function of the conductive current collector 112 is to concentrate the current, fix the catalytic layer and support the electrode structure, and the conductive current collector 112 is a metal mesh or foam having a material selected from a group consisting of stainless steel, nickel, titanium and copper. The functions of the gas diffusion membranes 111, 111a and 111b are to allow oxygen to pass therethrough and prevent the electrolyte from outflowing, and the gas diffusion membranes 111, 111a and 111b are made of the same materials as the conductive agent 101 and the adhesive 102. That is, the gas diffusion membranes 111, 111a and 111b are made of the conductive agent and the adhesive. The conductive agent is selected from one of or at least one of, for example, carbon black, acetylene black, and carbon nanofibers. The adhesive is selected from one of polytetrafluoroethylene (PTFE), perfluoroethylene propylene copolymer (FEP) and polyvinylidene fluoride (PVDF). The gas diffusion membranes 111, 111a and 111b are manufactured by mixing, stirring and rolling. The steps for manufacturing the gas diffusion membranes 111, 111a and 111b are similar to the steps S1-S3, except that no catalyst is added, and the mixing ratio can be adjusted by one skilled in the art according to needs. The ratio of the conductive agent 101 is preferably higher than that of the adhesive 102. In the gas diffusion membrane 111, the ratio of the adhesive 102 is higher than that of the catalyst layer 100.

Based on the above-mentioned manufacturing method of the catalyst layer 100 of the present invention, relevant embodiments are proposed as follows.

TABLE 1

| | Material weight | |
|---|---|---|
| Embodiment 1 | percentage | Actual weight |
| Catalyst | MnO₂ 270 μm, 20% | MnO₂ 270 μm, 45 g |
| | MnO₂ 5 μm, 4% | MnO₂ 5 μm, 9 g |
| Conductive | XC72 46% | XC72, 103.5 g |
| agent | | |
| Adhesive | PTFE 30% | PTFE, 67.5 g |
| Solvent | Water and Ethanol | Ethanol 112 g |
| | | Water 665 g |

Regarding Embodiment 1 of the present invention, it is prepared according to the ratio of Table 1 above. Specifically, 45 g of MnO₂ with an average particle size of 270 μm, 9 g of MnO₂ with an average particle size of 5 μm, 103.5 g of XC72R and 67.5 g of PTFE are mixed with 112 g of 95% ethanol and 665 g of water and stirred by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer is laminated with a conductive current collector and a gas diffusion membrane (thickness of 1.2 mm) to obtain an electrode (or a cathode) with a thickness of 1.87 mm.

TABLE 2

| | Material weight | |
|---|---|---|
| Embodiment 2 | percentage | Actual weight |
| Catalyst | MnO₂ 270 μm, 35% | MnO₂ 270 μm, 78.75 g |
| | MnO₂ 50 μm, 7% | MnO₂ 50 μm, 15.75 g |
| Conductive | XC72R 25% | XC72R, 56.25 g |
| agent | VGCF-H 3% | VGCF-H, 6.75 g |
| Adhesive | PTFE 30% | PTFE, 67.5 g |
| Solvent | Water and Ethanol | Ethanol 112 g |
| | | Water 665 g |

Regarding Embodiment 2 of the present invention, it is prepared according to the ratio of Table 2 above. Specifically, 78.75 g of MnO₂ with an average particle size of 270 μm, 15.75 g of MnO₂ with an average particle size of 50 μm, 56.25 g of XC72R, 6.75 g of VGCF-H and 67.5 g of PTFE are mixed with 112 g of 95% ethanol and 665 g of water and stirred by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer is laminated with a conductive current collector and a gas diffusion membrane (thickness of 1.2 mm) to obtain an electrode (or a cathode) with a thickness of 1.87 mm.

TABLE 3

| | Material weight | |
|---|---|---|
| Embodiment 3 | percentage | Actual weight |
| Catalyst | MnO₂ 150 μm, 35% | MnO₂ 150 μm, 78.75 g |
| | MnO₂ 5 μm, 7% | MnO₂ 5 μm, 15.75 g |
| Conductive | XC72 38% | XC72, 85.5 g |
| agent | | |
| Adhesive | PTFE 20% | PTFE, 45 g |
| Solvent | Water and Ethanol | Ethanol 114 g |
| | | Water 662 g |

Regarding Embodiment 3 of the present invention, it is prepared according to the ratio of Table 3 above. Specifically, 78.75 g of MnO₂ with an average particle size of 150 μm, 15.75 g of MnO₂ with an average particle size of 5 μm, 85.5 g of XC72R and 45 g of PTFE are mixed with 114 g of 95% ethanol and 662 grams of water and stirred by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer is laminated with a conductive current collector and a gas diffusion membrane (thickness of 1.2 mm) to obtain an electrode (or a cathode) with a thickness of 1.87 mm.

TABLE 4

| | Material weight | |
|---|---|---|
| Embodiment 4 | percentage | Actual weight |
| Catalyst | MnO₂ 150 μm, 30% | MnO₂ 150 μm, 67.5 g |
| | MnO₂ 50 μm, 6% | MnO₂ 50 μm, 13.5 g |
| Conductive | XC72 44% | XC72, 99 g |
| agent | | |
| Adhesive | PTFE 20% | PTFE, 45 g |
| Solvent | Water and Ethanol | Ethanol 114 g |
| | | Water 662 g |

Regarding Embodiment 4 of the present invention, it is prepared according to the ratio of Table 4 above. Specifically, 67.5 g of MnO₂ with an average particle size of 150 μm, 13.5 g of MnO₂ with an average particle size of 50 μm, 99 g of XC72R and 45 g of PTFE are mixed with 114 g of 95% ethanol and 662 g of water and stirred by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer is laminated with a conductive current collector and a gas diffusion membrane (thickness of 1.2 mm) to obtain an electrode (or a cathode) with a thickness of 1.87 mm.

TABLE 5

| | Material weight | |
|---|---|---|
| Embodiment 5 | percentage | Actual weight |
| Catalyst | MnO₂ 150 μm, 6% | MnO₂ 150 μm, 13.5 g |
| | MnO₂ 50 μm, 30% | MnO₂ 50 μm, 67.5 g |
| Conductive | XC72R 31% | XC72R, 69.75 g |
| agent | VGCF-H 3% | VGCF-H, 6.75 g |
| Adhesive | PTFE 30% | PTFE, 67.5 g |
| Solvent | Water and Ethanol | Ethanol 112 g |
| | | Water 665 g |

Regarding Embodiment 5 of the present invention, it is prepared according to the ratio of Table 5 above. Specifically, 13.5 g of MnO₂ with an average particle size of 150 μm, 67.5 g of MnO₂ with an average particle size of 50 μm, 69.75 g of XC72R, 6.75 g of VGCF-H and 67.5 g of PTFE are mixed with 112 g of 95% ethanol and 665 g of water and stirred by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer is laminated with a conductive current collector and a gas diffusion membrane (thickness of 1.2 mm) to obtain an electrode (or a cathode) with a thickness of 1.87 mm.

TABLE 6

| Comparative | Material weight | |
|---|---|---|
| Example | percentage | Actual weight |
| Catalyst | MnO₂ 150 μm, 20% | MnO₂ 150 μm, 45.0 g |
| Conductive | XC72R 50% | XC72R, 112.5 g |
| agent | | |
| Adhesive | PTFE 30% | PTFE, 67.5 g |
| Solvent | Water and Ethanol | Ethanol 112 g |
| | | Water 665 g |

Regarding a comparative example of a single average particle size of the present invention, it is prepared according to the ratio of Table 6 above. Specifically, 45.0 g of MnO₂ with a single average particle size of 150 μm (as in the above-mentioned Embodiments 1-5, the single average particle size refers to the D50 value calculated by a laser particle size analyzer known in the art), 112.5 g of XC72R, 67.5 g of PTFE, 112 g of 95% ethanol and 665 g of water are mixed by the DLH DC mixer (YOTEC CORPORATION, MRB-3500L) at 200 rpm for 10 minutes, and a gelatinous first mixture is produced after thorough mixing. The gelatinous first mixture is then stirred by the planetary mixer (THINKY CORPORATION) at 1900 rpm for 5 minutes to obtain an agglomerated second mixture. The agglomerated second mixture is then rolled into a catalytic layer with a thickness of 0.78 mm using the roller compactor (EKTRON TEK CO., LTD., EKT-2100SLM) at 25° C. and 50 rpm. Finally, the catalytic layer was laminated with a conductive current collector and a gas diffusion membrane (thickness of 1.2 mm) to obtain an electrode (or a cathode) with a thickness of 1.87 mm.

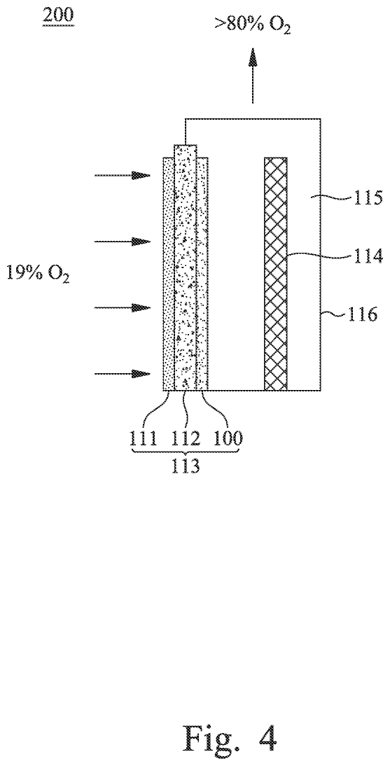

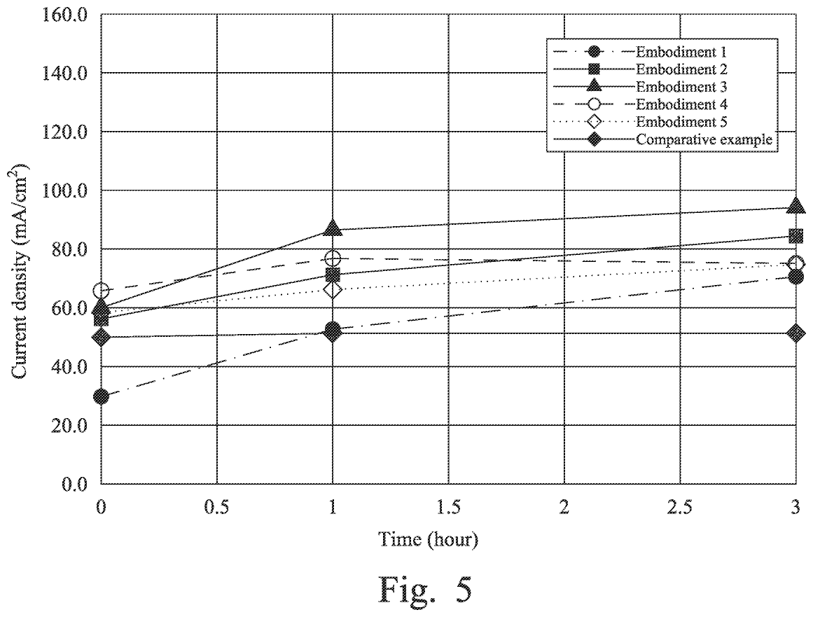

FIG. 4 is a schematic diagram showing the structure of an oxygen generating apparatus with the electrodes of the embodiments 1-5 and the comparative example, to perform the test. In order to test the performance of the electrodes made of different materials, a simplified oxygen generating apparatus 200 is proposed. As shown in FIG. 4, in a container 116 having an electrolyte 115 (30% sodium hydroxide), a part of the cathode 113 is manufactured according to the manufacturing steps of the above-mentioned embodiments and the comparative example, and the nickel mesh used as the anode 114 is placed inside the container 116. In the container 116, the catalytic layer 100 of the cathode 113 and the anode 114 are soaked with the electrolyte 115. The gas diffusion layer 111 of the cathode 113 is disposed outside the container 116, and the catalytic layer 100 is inside the container 116, so that oxygen in the atmosphere can enter the container 116 through the gas diffusion layer 111. When a voltage is applied, the oxygen generating apparatus 200 allows oxygen from the atmosphere to generate a higher concentration oxygen via the electrochemical reaction of the catalytic layer 100 with the anode 114, which can concentrate only 19% oxygen in the atmosphere to more than 80% oxygen in the oxygen generating apparatus 200. The surface areas of the cathode 113 and the anode 114 are 100 cm², which can be used in portable oxygen generating apparatus. During the test, a voltage of 1V was applied to the electrode to measure the current value, and the current value was divided by the area to obtain the current density value. The results are shown in FIG. 5.

FIG. 5 is a line graph showing the changes of the relationship between the current density per unit area and time of the embodiments 1-5 and the comparative example of the present invention. The higher the current density per unit area, the better the electrochemical reaction capability, and thus the oxygen production efficiency of the electrodes of the embodiments of the present invention can be evaluated. This test is carried out by combining the cathodes of the embodiments 1-5 with potassium hydroxide electrolyte and anode Ni mesh. It can be seen in FIG. 5 that the current densities per unit area of the embodiments 1-5 obtained by the catalysts with double average particle sizes of the present invention are all larger than that obtained by the catalysts with the single average particle size in the comparative example. Although the performance of Embodiment 1 is not as good as that of the comparative example in the first hour, the effect is gradually increased after 1 hour, and it is close to the performances of embodiments 4 and 5 after 3 hours. That is to say, because the ratio of adhesive to catalyst is different, the starting value of each Embodiment is also different, but the final result is still better than the catalyst with the single average particle size range. It can be seen in FIG. 5 that the performance of embodiment 3 is obviously the best.

While the invention has been described in terms of what is presently considered to be the most practical and preferred embodiments, it is to be understood that the invention need not be limited to the disclosed embodiments. Therefore, it is intended to cover various modifications and similar configurations included within the spirit and scope of the appended claims, which are to be accorded with the broadest interpretation so as to encompass all such modifications and similar structures.

What is claimed is:

1. A method for manufacturing an electrode, comprising steps of:
mixing a first catalyst having a first average particle size, a second catalyst having a second average particle size, a first conductive agent, a first adhesive and a solvent to form a first mixture, wherein a weight ratio of the first catalyst to the second catalyst is 5:1 to 1:5;
stirring the first mixture to obtain a second mixture;
rolling the second mixture into a catalytic layer; and
laminating the catalytic layer, a conductive current collector and a gas diffusion membrane to obtain the electrode.

2. The method for manufacturing the electrode as claimed in claim 1, wherein:
the gas diffusion membrane comprises a second conductive agent and a second adhesive;
either of the first catalyst and the second catalyst has a material selected from the group consisting of ruthenium dioxide, iridium dioxide, manganese dioxide, cobalt oxide, cobalt tetroxide, nickel hydroxide, nickel oxide, iron oxide, tungsten trioxide, vanadium pentoxide and palladium oxide.

3. The method for manufacturing the electrode as claimed in claim 1, wherein:
either of the first conductive agent and the second conductive agent has a material selected from a group consisting of carbon black, acetylene black and carbon nanofibers;
either of the first adhesive and the second adhesive has a material selected from a group consisting of polytetrafluoroethylene (PTFE), perfluoroethylene propylene copolymer (FEP) and polyvinylidene fluoride (PVDF);
the solvent is water, alcohol, or a combination thereof; and
the conductive current collector is a metal mesh or foam having a material selected from a group consisting of stainless steel, nickel, titanium and copper.

4. The method for manufacturing the electrode as claimed in claim 1, wherein:
a rotating speed in either of the mixing step and the stirring step is 100-2000 rpm;
the stirring step includes at least one of a gravity centrifugal stirring step and a blade shearing stirring step; and
the laminating step uses a roller device with a condition including a rolling speed below 30 rpm and a temperature below 150° C.

5. The method for manufacturing an electrode as claimed in claim 1, wherein the first average particle size is in a range of 150-270 μm, the second average particle size is in a range of 5-50 μm, and the first average particle size is 3-54 times of the second average particle size.

6. A method of manufacturing an electrode, comprising steps of:
mixing a catalyst, a first conductive agent, a first adhesive and a solvent to form a first mixture, wherein the catalyst includes a relatively large particle size catalyst and a relatively small particle size catalyst;
stirring the first mixture to obtain a second mixture;
rolling the second mixture into a catalytic layer; and
laminating the catalytic layer, a conductive current collector and a gas diffusion membrane to obtain the electrode.

7. The method for manufacturing the electrode as claimed in claim 6, wherein:
the gas diffusion membrane comprises a second conductive agent and a second adhesive;
either of the relatively large particle size catalyst and the relatively small particle size catalyst has a material selected from the group consisting of ruthenium dioxide, iridium dioxide, manganese dioxide, cobalt oxide, cobalt tetroxide, nickel hydroxide, nickel oxide, iron oxide, tungsten trioxide, vanadium pentoxide and palladium oxide.

8. The method for manufacturing the electrode as claimed in claim 6, wherein:
either of the first conductive agent and the second conductive agent has a material selected from a group consisting of carbon black, acetylene black and carbon nanofibers;
either of the first adhesive and the second adhesive has a material selected from a group consisting of polytetrafluoroethylene (PTFE), perfluoroethylene propylene copolymer (FEP) or polyvinylidene fluoride (PVDF);
the solvent is water, alcohol, or a combination thereof; and
the conductive current collector is a metal mesh or foam having a material selected from a group consisting of stainless steel, nickel, titanium and copper.

9. The method for manufacturing the electrode as claimed in claim 6, wherein:
a rotating speed in either of the mixing step and the stirring step is 100-2000 rpm;
the stirring step includes at least one of a gravity centrifugal stirring step and a blade shearing stirring step; and
the laminating step has a condition including a rolling speed below 30 rpm and a temperature below 150° C.

10. The method for manufacturing the electrode as claimed in claim 6, wherein the relatively large particle size catalyst has an average particle size of 150-270 μm, the relatively small particle size catalyst has an average particle size of 5-50 μm, and an average particle size of the relatively large particle size catalyst is 3-54 times that of the relatively small particle size catalyst.

11. A catalytic layer of an electrode, comprising:
a relatively large particle size catalyst;
a relatively small particle size catalyst;
a conductive agent; and
an adhesive, wherein:
the relatively large particle size catalyst has a first average particle size;
the relatively small particle size catalyst has a second average particle size; and
the first average particle size is larger than the second average particle size.

12. The catalytic layer as claimed in claim 11, wherein the first average particle size is 150-270 μm, the second average particle size is 5-50 μm, the first average particle size is 3-54 times the second average particle size, and the weight ratio of the relatively large particle size catalyst to the relatively small particle size catalyst is 5:1 to 1:5.

13. The catalytic layer as claimed in claim 11, wherein either of the relatively large particle size catalyst and the relatively small particle size catalyst has a material selected from the group consisting of ruthenium dioxide, iridium dioxide, manganese dioxide, cobalt oxide, cobalt tetroxide, nickel hydroxide, nickel oxide, iron oxide, tungsten trioxide, vanadium pentoxide and palladium oxide.

14. The catalytic layer as claimed in claim 11, wherein:
the conductive agent has a material selected from a group consisting of carbon black, acetylene black and carbon nanofibers;
the adhesive has a material selected from a group consisting of polytetrafluoroethylene (PTFE), perfluoroethylene propylene copolymer (FEP) and polyvinylidene fluoride (PVDF).
